(19) United States
(12) Patent Application Publication
(10) Pub. No.: US 2021/0010513 A1
(43) Pub. Date: Jan. 14, 2021

(54) OLIVE-SHAPED ASYMMETRIC BIDIRECTIONAL TAPERED THREAD CONNECTION PAIR WITH SMALLER LEFT TAPER AND GREATER RIGHT TAPER

(71) Applicant: AMICUS VERITATIS MACHINERY CO., LTD., Taizhou (CN)

(72) Inventor: Yihua You, Taizhou (CN)

(21) Appl. No.: 17/030,879

(22) Filed: Sep. 24, 2020

Related U.S. Application Data
(63) Continuation of application No. PCT/CN2019/081376, filed on Apr. 4, 2019.

(30) Foreign Application Priority Data
Apr. 7, 2018 (CN) 201810303106.7

(51) Int. Cl. F16B 35/04

(52) U.S. Cl. CPC F16B 35/041

(57) ABSTRACT

The present invention belongs to the field of general technology of device, and relates to an olive-shaped asymmetric bidirectional tapered thread connection pair with smaller left taper and greater right taper, which solves the problems of poor self-positioning and self-locking performance of existing threads, wherein an internal thread (6) is a bidirectional tapered hole (41) (non-entity space) on an inner surface of a cylindrical body (2); an external thread (9) is a bidirectional truncated cone body (71) (material entity) on an outer surface of a columnar body (3), and a complete unit thread is a helical special bidirectional tapered body in an olive-like shape (93) with a left taper (95) smaller than a right taper (96) and with a large middle and two small ends.

### CROSS-REFERENCE TO RELATED APPLICATIONS

This application is a continuation of International Patent Application No. PCT/CN2019/081376, filed on Apr. 4, 2019, entitled “Olive-Shaped Asymmetric Bidirectional Tapered Thread Connection Pair with Smaller Left Taper and Greater Right Taper” which claims priority to China Patent Application No. 201810303106.7, filed on Apr. 7, 2018. The content of these identified applications are hereby incorporated by references.

### TECHNICAL FIELD

The present invention belongs to the field of general technology of device, and particularly relates to an olive-shaped asymmetric bidirectional tapered thread connection pair with smaller left taper and greater right taper, i.e., an olive-like shaped (left taper is smaller than right taper) asymmetric bidirectional tapered thread connection pair (hereinafter referred to as “the olive-like asymmetric bidirectional tapered thread connection pair”).

### BACKGROUND OF THE PRESENT INVENTION

The invention of thread has a profound impact on the progress of human society. Thread is one of the most basic industrial technologies. It is not a specific product, but a key generic technology in the industry. It has the technical performance that must be embodied by specific products as application carriers, and is widely applied in various industries. The existing thread technology has high standardization level, mature technical theory and long-term practical application. It is a fastening thread when used for fastening, a sealing thread when used for sealing, and is a transmission thread when used for transmission. According to the thread terminology of national standards, the “thread” refers to tooth bodies having the same thread profile and continuously protruding along a helical line on a cylindrical or conical surface; and the “tooth body” refers to a material entity between adjacent flanks. This is also the definition of thread under global consensus.

The modern thread began in 1841 with British Whitworth thread. According to the theory of modern thread technology, the basic condition for self-locking of the thread is that an equivalent friction angle shall not be smaller than a helical rise angle. This is an understanding for the thread technology in modern thread based on a technical principle-“principle of inclined plane”, which has become an important theoretical basis of the modern thread technology. Simon Stevin was the first to explain the principle of inclined plane theoretically. He has researched and discovered the parallelogram law for balancing conditions and force composition of objects on the inclined plane. In 1586, he put forward the famous inclined plane law that the gravity of an object placed on the inclined plane in the direction of inclined plane is proportional to the sine of inclination angle. The inclined plane refers to a smooth plane inclined to the horizontal plane; the helix is a deformation of the “inclined plane”; the thread is like an inclined plane wrapped around the cylinder; and the flatter the inclined plane is, the greater the mechanical advantage is (see FIG. 8) (Jingshan Yang and Xiuya Wang, Discussion on the Principle of Screws, Disquisitions Arithmeticae of Gauss).

The “principle of inclined plane” of the modern thread is an inclined plane slider model (see FIG. 9) which is established based on the law of inclined plane. It is believed that the thread pair meets the requirements of self-locking when a thread rise angle is less than or equal to the equivalent friction angle under the condition of little change of static load and temperature. The thread rise angle (see FIG. 10), also known as thread lead angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century; and the technical principle of the wedge thread still follows the “principle of inclined plane”. The invention of the wedge thread was inspired by the “wooden wedge”. Specifically, the wedge thread has a structure that a wedge-shaped inclined plane forming an angle of 25°-30° with the thread axis is located at the root of internal threads (i.e., nut threads) of triangular threads (commonly known as common threads); and a wedge-shaped inclined plane of 30° is adopted in engineering practice. For a long time, people have studied and solved the anti-loosening and other problems of the thread from the technical level and technical direction of thread profile angle. The wedge thread technology is also a specific application of the inclined wedge technology without exception.

Modern threads are of various types and forms and are all tooth threads, which is determined by their technical principles, i.e., inclined plane principles. Specifically, threads formed on cylindrical surfaces are called cylindrical threads; threads formed on conical surfaces are called conical threads; threads formed on end faces of cylinders or truncated cone bodies and the like are called plane threads; threads formed on excircle surfaces of bodies are called external threads; threads formed on inner round hole surfaces of the bodies are called internal threads; threads formed on end faces of the bodies are called end-face threads; threads of which screwing directions and thread rise angle directions are in accordance with a left-hand rule are called left-hand threads; threads of which the screwing directions and thread rise angle directions are in accordance with a right-hand rule are called right-hand threads; threads that have one helical line only in the same section of the bodies are called single-line threads; threads with two helical lines are called double-line threads; and threads with multiple helical lines are called multi-line threads. Threads having triangular section shapes are called triangular threads; threads having trapezoidal section shapes are called trapezoidal threads; threads having rectangular section shapes are called rectangular threads; and threads having sawtooth-shaped section shapes are called sawtooth threads.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY OF THE INVENTION

Any technical theory has theoretical hypothesis background; and the thread is not an exception. With the development of science and technology, the damage to connection is not simple linear load, static or room temperature environment; and linear load, nonlinear load and even the superposition of the two cause more complex load damaging conditions and complex application conditions. Based on such recognition, the object of the present invention is to provide an olive-like shaped asymmetric bidirectional tapered thread connection pair with reasonable design, simple structure, and excellent connection performance and locking performance with respect to the above problems.

To achieve the above object, the following technical solution is adopted in the present invention: the olive-like shaped (left taper is smaller than right taper) asymmetric bidirectional tapered thread connection pair is used in such a manner that external threads of asymmetric bidirectional tapered threads and internal threads of asymmetric bidirectional tapered threads form a thread connection pair, and is a thread pair technology combining technical characteristics of a cone pair and a helical movement. The bidirectional tapered thread is a thread technology combining the technical characteristics of a bidirectional tapered body and a helical structure. The bidirectional tapered body is composed of two single tapered bodies. i.e., the bidirectional tapered body is composed of two single tapered bodies with reverse left taper and right taper and different tapers and taper of the left single taper body is smaller than that of the right single taper body. The bidirectional tapered body is helically distributed on the outer surface of a columnar body to form external threads and/or the bidirectional tapered body is helically distributed on the inner surface of a cylindrical body to form internal threads. Regardless of the internal threads or the external threads, a complete unit thread is a special olive-shaped bidirectional tapered geometry that is large in middle and small in two ends and has left taper smaller than right taper.

In the olive-like shaped asymmetric bidirectional tapered thread connection pair, the definition of the olive-like asymmetric bidirectional tapered thread can be expressed as “a helical olive-like special bidirectional tapered geometry that is large in middle and small in two ends, which has asymmetric bidirectional tapered holes (or asymmetric bidirectional truncated cone bodies) with specified left tapers and right tapers reverse in direction and left taper smaller than right taper and is continuously and/or discontinuously distributed along the helical line on cylindrical or conical surfaces”. The head and the tail of the asymmetric bidirectional tapered thread may be incomplete bidirectional tapered geometries due to manufacturing and other reasons. Different from the modern thread technology, for the number term of complete unit threads and/or incomplete unit threads, bidirectional tapered threads do not take “number of teeth” as a unit, but take “number of pitches” as the unit. Namely, the bidirectional tapered threads may not be called teeth of threads, but called pitches of threads. The change of the number term of the threads is caused based on connotation change of the thread technology. The thread technology has changed from the engagement relationship between the internal threads and the external threads of the modern threads to the present cohesion relationship between the internal threads and the external threads of the bidirectional tapered threads.

The olive-like shaped asymmetric bidirectional tapered thread connection pair comprises a bidirectional truncated cone body helically distributed on an outer surface of a columnar body, and a helical bidirectional tapered hole helically distributed in an inner surface of a cylindrical body, i.e., comprising an external thread and an internal thread in thread fit. The internal thread is a helically distributed bidirectional tapered hole and exists in the form of “non-entity space”. The external thread is distributed as a helical bidirectional truncated cone body and exists in the form of “material entity”. The non-entity space refers to a space environment capable of accommodating the above material entity. The internal thread is a containing part; and the external thread is a contained part. A working condition of the thread is as follows: the internal thread and the external thread are sleeved together by screwing bidirectional tapered geometries in pitches, and the internal and external threads are cohered till one side bears the load bidirectionally or the left side and the right side bear the load bidirectionally at the same time or till the sizing interference fit is achieved. Whether the two sides bear bidirectional load at the same time is related to the actual working conditions in the application field, i.e., the bidirectional tapered holes are fitted with the bidirectional truncated cone body pitch by pitch, i.e., the internal thread is fitted with the corresponding external thread in pitches.

The olive-shaped asymmetric bidirectional tapered thread connection pair is a thread pair formed by fitting a helical outer conical surface with a helical inner conical surface to form a cone pair. The outer conical surface of the external cone body of the bidirectional tapered thread and the inner conical surface of the internal cone body are bidirectional conical surfaces. When the thread connection pair is formed between the bidirectional tapered threads, a joint surface between the inner conical surface and the outer conical surface is used as a bearing surface. Namely, the conical surface is used as the bearing surface to realize the technical performance of connection. The self-locking, self-positioning, reusability, fatigue resistance and other capabilities of the thread pair mainly depend on the conical surface of the cone pair of the olive-like shaped asymmetric bidirectional tapered thread connection pair and taper size of the conical surface, i.e., the conical surface of the internal and external threads and the taper size of the conical surface. The thread pair is a non-toothed thread.

Different from that the principle of inclined plane of the existing thread which shows a unidirectional force distributed on the inclined plane as well as an engagement relationship between the inner tooth bodies and outer tooth bodies, the single tapered body distributed on either one of the left side or the right side of the external thread body, i.e., the bidirectional tapered body, of the olive-like shaped asymmetric bidirectional tapered thread connection pair is composed of two plain lines of the cone body in two directions through a cross section of a cone axis, i.e., in a bidirectional state, wherein the plain lines are intersection lines of the conical surfaces and a plane through which the cone axis passes. The cone principle of the olive-like shaped asymmetric bidirectional tapered thread connection pair shows an axial force and a counter-axial force, both of which are synthesized by bidirectional forces, wherein the axial force and the corresponding counter-axial force are opposite to each other. The internal thread and the external thread are in a cohesion relationship. Namely, the thread pair is formed by cohering the external thread with the internal thread, i.e., the tapered hole (internal cone) is cohered with the corresponding tapered cone body (external cone body) pitch by pitch till the self-positioning is realized by cohesion fit or till the self-locking is realized by interference contact. Namely, the self-locking or self-positioning of the internal cone body and the external cone body is realized by radially cohering the tapered hole and the truncated cone body to realize the self-locking or self-positioning of the thread pair, rather than the thread connection pair composed of the internal thread and the external thread in the traditional thread, which realizes its thread connection performance by mutual abutment between the tooth bodies.

A self-locking force will arise when the cohesion process between the internal thread and the external thread reaches certain conditions. The self-locking force is generated by a pressure produced between an axial force of the internal cone and a counter-axial force of the external cone. Namely, when the internal cone and the external cone form the cone pair, the inner conical surface of the internal cone body is fitted with the outer conical surface of the external cone body; and the inner conical surface is in close contact with the outer conical surface. The axial force of the internal cone and the counter-axial force of the external cone are concepts of forces unique to the bidirectional tapered thread technology of the present invention, i.e., the cone pair technology.

The internal cone body exists in a form similar to a shaft sleeve, and generates the axial force pointing to or pressing toward the cone axis under the action of external load. The axial force is bidirectionally combined by a pair of centripetal forces which are distributed in mirror image with the cone axis as a center and are respectively perpendicular to the two plain lines of the cone body; i.e., the axial force passes through the cross section of the cone axis and is composed of two centripetal forces which are bidirectionally distributed on two sides of the cone axis in mirror image with the cone axis being the center, are respectively perpendicular to the two plain lines of the cone body, and point to or press toward a common point of the cone axis; and the axial force passes through a cross section of a thread axis and is composed of two centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The axial force is densely distributed on the cone axis and/or the thread axis in an axial and circumferential manner, and corresponds to an axial force angle. The axial force angle is formed by an angle between two centripetal forces forming the axial force and depends on the taper of the cone body, i.e., the taper angle.

The external cone body exists in a form similar to a shaft, has relatively strong ability to absorb various external loads, and generates a counter-axial force opposite to each axial force of the internal cone body. The counter-axial force is bidirectionally combined by a pair of counter-centripetal forces which are distributed in mirror image with the cone axis as the center and are respectively perpendicular to the two plain lines of the cone body; i.e., the counter-axial force passes through the cross section of the cone axis and is composed of two counter-centripetal forces which are bidirectionally distributed on two sides of the cone axis in mirror image with the cone axis as the center, are respectively perpendicular to the two plain lines of the cone body, and point to or press toward the common point of the cone axis; and the counter-axial force passes through the cross section of the thread axis and is composed of two counter-centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The counter-axial force is densely distributed on the cone axis and/or the thread axis in the axial and circumferential manner, and corresponds to a counter-axial force angle. The counter-axial force angle is formed by an angle between the two counter-centripetal forces forming the counter-axial force and depends on the taper of the cone body, i.e., the taper angle.

The axial force and the counter-axial force start to be generated when the internal cone and the external cone of the cone pair are in effective contact, i.e., a pair of corresponding and opposite axial force and counter-axial force always exist during the effective contact of the internal cone and the external cone of the cone pair. The axial force and the counter-axial force are bidirectional forces bidirectionally distributed in mirror image with the cone axis and/or the thread axis as the center, rather than unidirectional forces. The cone axis and the thread axis are coincident axes, i.e., the same axis and/or approximately the same axis. The counter-axial force and the axial force are reversely collinear and are reversely collinear and/or approximately reversely collinear when the cone body and the helical structure are combined into the thread and form the thread pair. The internal cone and the external cone are engaged till interference is achieved, so the axial force and the counter-axial force generate a pressure on the contact surface between the inner conical surface and the outer conical surface and are densely and uniformly distributed on the contact surface between the inner conical surface and the outer conical surface axially and circumferentially. When the cohesion movement of the internal cone and the external cone continues till the cone pair reaches the pressure generated by interference fit to combine the internal cone with the external cone, i.e., the pressure enables the internal cone body to be engaged with the external cone body to form a similar integral structure and will not cause the internal cone body and the external cone body to separate from each other under the action of gravity due to arbitrary changes in a direction of a body position of the similar integral structure after the external force caused by the pressure disappears. The cone pair generates self-locking, which means that the thread pair generates self-locking. The self-locking performance has a certain degree of resistance to other external loads which may cause the internal cone body and the external cone body to separate from each other except gravity. The cone pair also has the self-positioning performance which enables the internal cone and the external cone to be fitted with each other, but not any axial force angle and/or counter-axial force angle can make the cone pair generate self-locking and self-positioning.

When the axial force angle and/or the counter-axial force angle is less than 180° and greater than 127°, the cone pair has the self-locking performance. When the axial force angle and/or the counter-axial force angle is infinitely close to 180°, the cone pair has the best self-locking performance and the weakest axial bearing capacity. When the axial force angle and/or the counter-axial force angle is equal to and/or less than 127° and greater than 0°, the cone pair is in a range of weak self-locking performance and/or no self-locking performance. When the axial force angle and/or the counter-axial force angle tends to change in a direction infinitely close to 0°, the self-locking performance of the cone pair changes in a direction of attenuation till the cone pair completely has no self-locking ability; and the axial bearing capacity changes in a direction of enhancement till the axial bearing capacity is the strongest.

When the axial force angle and/or the counter-axial force angle is less than 180° and greater than 127°, the cone pair is in a strong self-positioning state, and the strong self-positioning of the internal cone body and the external cone body is easily achieved. When the axial force angle and/or the counter-axial force angle is infinitely close to 180°, the internal cone body and the external cone body of the cone pair have the strongest self-positioning ability. When the axial force angle and/or the counter-axial force angle is equal to and/or less than 127° and greater than 0°, the cone pair is in a weak self-positioning state. When the axial force angle and/or the counter-axial force angle tends to change in the direction infinitely close to 0°, the mutual self-positioning ability of the internal cone body and the external cone body of the cone pair changes in the direction of attenuation till the cone pair is close to have no self-positioning ability at all.

Compared with the containing and contained relationship of irreversible one-sided bidirectional containment that the unidirectional tapered thread of single tapered body invented by the applicant before which can only bear the load by one side of the conical surface, the bidirectional tapered thread connection pair, compared with allows the reversible left and right-sided bidirectional containment of the bidirectional tapered threads of double tapered bodies, enabling the left side and/or the right side of the conical surface to bear the load, and/or the left conical surface and the right conical surface to respectively bear the load, and/or the left conical surface and the right conical surface to simultaneously bear the load bidirectionally, and further limiting a disordered degree of freedom between the tapered hole and the truncated cone body; and the helical movement enables the asymmetric bidirectional tapered thread connection pair to obtain a necessary ordered degree of freedom, thereby effectively synthesizing the technical characteristics of the cone pair and the thread pair to form a brand-new thread technology.

When the olive-like shaped asymmetric bidirectional tapered thread connection pair is used, the conical surface of the bidirectional truncated cone body of the external thread of the bidirectional tapered thread and the conical surface of the bidirectional tapered hole of the internal thread of the bidirectional tapered thread are fitted with each other.

According to the olive-like shaped asymmetric bidirectional tapered thread connection pair, the self-locking or self-positioning of the thread connection pair is not realized at any taper or any taper angle of the bidirectional tapered body of the cone pair, i.e., the truncated cone body and/or the tapered hole. The olive-shaped asymmetric bidirectional tapered thread connection pair has the self-locking and self-positioning performances only when the internal and external cone bodies of the bidirectional tapered body reach a certain taper, or a certain taper. The taper comprises the left taper and the right taper of the internal and external threads. The taper angle comprises left taper angles and right taper angles of the internal and external thread bodies. The internal thread and the external thread of the asymmetric bidirectional tapered thread forming the olive-shaped asymmetric bidirectional tapered thread connection pair have the left taper smaller than the right taper. For the taper angle, the left taper corresponds to a first taper angle α1. Preferably, the first taper angle α1 is greater than 0° and smaller than 53°; and preferably, the first taper angle α1 is 2°-40°. The right taper corresponds to the right taper angle. The right taper angle is a second taper angle α2. It is preferable that the second taper angle α2 is greater than 0° and smaller than 53°; and preferably, the second taper angle α2 is 2°-40°. In individual special fields, preferably, the second taper angle α2 is greater than or equal to 53° and smaller than 180°; and preferably, the second taper angle α1 is 53°-90°.

The above-mentioned individual special fields refer to the application fields of thread connection such as transmission connection with low requirements on self-locking performance or even without self-locking performance and/or with low requirements on self-positioning performance and/or with high requirements on axial bearing capacity and/or with indispensable anti-locking measures.

In the olive-like shaped asymmetric bidirectional tapered thread connection pair, the external thread is arranged on the outer surface of the columnar body, wherein a truncated cone body is helically distributed on the outer surface of the columnar body, comprising an asymmetric bidirectional truncated cone body. The columnar body may be solid or hollow, comprising cylindrical and/or non-cylindrical workpieces and objects that need to be machined with threads on the outer surfaces. The outer surfaces comprise cylindrical surfaces, non-cylindrical surfaces such as conical surfaces, and outer surfaces.

According to the olive-like shaped asymmetric bidirectional tapered thread connection pair, the asymmetric bidirectional truncated cone body, i.e., the external thread is formed by symmetrically and oppositely jointing lower bottom surfaces of two tapered holes with the same lower bottom surfaces and upper top surfaces and different cone heights in a helical shape to form the thread. The upper top surfaces are located at both ends of the bidirectional truncated cone body to form the asymmetric bidirectional tapered thread, comprising that the lower bottom surfaces are respectively jointed with the upper top surfaces of the adjacent bidirectional truncated cone bodies and/or to be respectively jointed with the upper top surfaces of the adjacent bidirectional truncated cone bodies in the helical shape to form the thread. The external thread comprises a first helical conical surface of the truncated cone body, a second helical conical surface of the truncated cone body and an external helical line, so as to form the asymmetric bidirectional tapered external thread. In the cross section through which the thread axis passes, the complete single-pitch asymmetric bidirectional tapered internal thread, is a special bidirectional tapered geometry in the olive-like shape and with a large middle and two small ends and left taper smaller than right taper. The angle formed between the two plain lines of the left conical surface of the bidirectional truncated cone body comprising the conical surface of the bidirectional truncated cone body, is the first taper angle α1. The left taper is formed on the first helical conical surface of the tapered hole and is subjected to a left-direction distribution. The angle formed between the two plain lines of the right conical surface, i.e., the second helical conical surface of the tapered hole, is the second taper angle α2. The right taper is formed on the second helical conical surface of the tapered hole and is subjected to a right-direction distribution. The taper directions corresponding to the first taper angle α1 and the second taper angle α2 are opposite. The plain line is an intersection line of the conical surface and the plane through which the cone axis passes. The shape formed by the first helical conical surface and the second helical conical surface of the tapered hole of the bidirectional tapered hole is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body, wherein the right-angled side is coincident with the central axis of the columnar body; and the right-angled trapezoid union is formed by symmetrically and oppositely jointing lower bottom sides of two right-angled trapezoids with the same lower bottom sides and upper bottom sides and different right-angled sides. The right-angled trapezoid union refers to a special geometry, which is formed by symmetrically and oppositely jointing the lower bottom sides of two right-angled trapezoids with the same lower bottom sides and upper bottom sides and different right-angled sides and has the upper bottom sides respectively located at both ends of the right-angled trapezoid union.

According to the olive-like shaped asymmetric bidirectional tapered thread connection pair, the internal thread is arranged on the inner surface of the cylindrical body, wherein a tapered hole is helically distributed in the inner surface of the cylindrical body. The tapered hole comprises an asymmetric bidirectional tapered hole. The cylindrical body comprises cylindrical and/or non-cylindrical workpieces and objects which need to be machined with the internal threads in the inner surfaces thereof, wherein the inner surfaces comprise geometric shapes of inner surfaces such as cylindrical surfaces, non-cylindrical surfaces such as conical surfaces, and the like.

In the olive-like shaped asymmetric bidirectional tapered thread connection pair, the asymmetric bidirectional truncated cone body, i.e., the internal thread is formed by symmetrically and oppositely jointing lower bottom surfaces of two tapered holes with the same lower bottom surfaces and upper top surfaces and different cone heights and taper of a left tapered hole smaller than taper of a right tapered hole in a helical shape to form the thread. The upper top surfaces are located at both ends of the bidirectional truncated cone body to form the asymmetric bidirectional tapered thread, comprising that the lower bottom surfaces are respectively jointed with the upper top surfaces of the adjacent bidirectional truncated cone bodies and/or will be respectively jointed with the upper top surfaces of the adjacent bidirectional truncated cone bodies in the helical shape to form the thread. The internal thread comprises a first helical conical surface of the tapered hole, a second helical conical surface of the tapered hole and an internal helical line, so as to form the asymmetric bidirectional tapered internal thread. In the cross section through which the thread axis passes, the complete single-pitch asymmetric bidirectional tapered internal thread, is a special bidirectional tapered geometry in the olive-like, shape and with a large middle and two small ends and left taper smaller than right taper. The angle formed between the two plain lines of the left conical surface of the bidirectional tapered hole comprising the conical surface of the bidirectional tapered hole, is the first taper angle α1. The left taper is formed on the first helical conical surface of the tapered hole and is subjected to a left-direction distribution. The angle formed between the two plain lines of the right conical surface, i.e., the second helical conical surface of the tapered hole, is the second taper angle α2. The right taper is formed on the second helical conical surface of the tapered hole and is subjected to a right-direction distribution. The taper directions corresponding to the first taper angle α1 and the second taper angle α2 are opposite. The plain line is an intersection line of the conical surface and the plane through which the cone axis passes. The shape formed by the first helical conical surface and the second helical conical surface of the tapered hole of the bidirectional tapered hole is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body, wherein the right-angled side is coincident with the central axis of the columnar body; and the right-angled trapezoid union is formed by symmetrically and oppositely jointing lower bottom sides of two right-angled trapezoids with the same lower bottom sides and upper bottom sides and different right-angled sides. The right-angled trapezoid union refers to a special geometry, which is formed by symmetrically and oppositely jointing the lower bottom sides of two right-angled trapezoids with the same lower bottom sides and upper bottom sides and different right-angled sides and has the upper bottom sides respectively located at both ends of the right-angled trapezoid union.

In the olive-like shaped asymmetric bidirectional tapered thread connection pair, connected forms such as sharp angles and/or non-sharp angles respectively exist at the joint of two adjacent helical conical surfaces of the external thread and two adjacent helical conical surfaces of the internal thread. Relative to the non-sharp angle, the sharp angle refers to a structural form that is not specially subjected to non-sharp angle treatment.

In the olive-like shaped asymmetric bidirectional tapered thread connection pair, when the connected form is the sharp angle, the joints between the first helical conical surface of the truncated cone body of the bidirectional truncated cone body and the second helical conical surface of the truncated cone body in the same helix, i.e., large diameters of the external thread, are connected by an external sharp angle structure, and an external helical line distributed helically is formed. The joints between the first helical conical surface of the truncated cone body of the bidirectional truncated cone body and the second helical conical surface of a truncated cone body adjacent to the bidirectional truncated cone body in the same helix, and/or the joints between the second helical conical surface of the truncated cone body of the bidirectional truncated cone body and the first helical conical surface of a truncated cone body adjacent to the bidirectional truncated cone body in the same helix, i.e., small diameters of the internal thread, are connected by an internal sharp angle shape structure, and an internal helical line distributed helically is formed. The joints between the first helical conical surface of the tapered hole of the bidirectional tapered hole and the second helical conical surface of a tapered hole body adjacent to the bidirectional tapered hole in the same helix, and/or the joints between the second helical conical surface of the tapered hole of the bidirectional tapered hole and the first helical conical surface of a tapered hole adjacent to the bidirectional tapered hole in the same helix, i.e., small diameters of the internal thread, are connected by an external sharp angle shape structure, and an internal helical line distributed helically is formed. The more compact the thread structure is, the higher the strength is, and the higher the force bearing value is. Excellent mechanical connection, locking and sealing performances are achieved; and physical machining spaces of the tapered threads are wider.

In the olive-like shaped asymmetric bidirectional tapered thread connection pair, when the connected form is the non-sharp angle, the joints between the first helical conical surface of the truncated cone body of the bidirectional truncated cone body and the second helical conical surface of the truncated cone body in the same helix, i.e., the large diameters of the external thread, are connected by a non-external sharp angle, and an external helical structure that is helically distributed or is flat or arc is formed. The joints between the first helical conical surface of the truncated cone body of the bidirectional truncated cone body and the second helical conical surface of a truncated cone body adjacent to the bidirectional truncated cone body in the same helix, and/or the joints between the second helical conical surface of the truncated cone body of the bidirectional truncated cone body and the first helical conical surface of a truncated cone body adjacent to the bidirectional truncated cone body in the same helix, i.e., small diameters of the external thread, are connected by a non-internal sharp angle shape structure, and an external helical structure that is distributed helically or is grooved or arc-shaped is formed. The joints between the first helical conical surface of the tapered hole of the bidirectional tapered hole and the second helical conical surface of a tapered hole body adjacent to the bidirectional tapered hole in the same helix, and/or the joints between the second helical conical surface of the tapered hole of the bidirectional tapered hole and the first helical conical surface of a tapered hole adjacent to the bidirectional tapered hole in the same helix, i.e., large diameters of the internal thread, are connected by a non-external sharp angle shape structure, and an internal helical structure that is distributed helically or is grooved or arc-shaped is formed. The joints between the first helical conical surface of the tapered hole of the bidirectional tapered hole and the second helical conical surface of a tapered hole adjacent to the bidirectional tapered hole in the same helix, and/or the joints between the second helical conical surface of the tapered hole of the bidirectional tapered hole and the first helical conical surface of a tapered hole adjacent to the bidirectional tapered hole in the same helix, i.e., small diameters of the internal thread, are connected by a non-external sharp angle shape structure, and an internal helical structure that is distributed helically or is flat or arc-shaped is formed. The non-external sharp angle means that the section is planar or arc or of other geometrical shapes. The non-internal sharp angle means that the section is grooved or arc-shaped or of other geometrical shapes. Thus, interference between the internal thread and the external thread during screwing may be avoided, and oil or dirt may be stored. Actual applications depend on the circumstance. The small diameters of the external threads and the large diameters of the internal threads may be of grooved or arc structures, while the large diameters of the external threads and the small diameters of the internal threads are of sharp angle structures and/or the large diameters of the external threads and the small diameters of the internal threads are of planar or arc structures. The small diameters of the external threads and the large diameters of the internal threads are of sharp angle structures and/or the small diameters of the external threads and the large diameters of the internal threads are of grooved or arc structures. The large diameters of the external thread and the small diameters of the internal threads are of planar or arc structures.

In the olive-like shaped asymmetric bidirectional tapered thread connection pair, during transmission connection, by virtue of screwed connection between the bidirectional tapered internal thread, i.e., the bidirectional tapered hole and the bidirectional tapered external thread, i.e., the bidirectional truncated cone body and bidirectional bearing, a clearance must be reserved between the bidirectional tapered external thread and the bidirectional tapered internal thread. If oil and other media exist between the internal thread and the external thread for lubrication, a bearing oil film will be easily formed; and the clearance is beneficial to the formation of the bearing oil film. The olive-like shaped asymmetric bidirectional tapered thread connection pair applied to transmission connection is equivalent to a set of sliding bearing pairs composed of one and/or several pairs of sliding bearings, i.e., each pitch of the bidirectional tapered internal thread bidirectionally contains a corresponding pitch of bidirectional tapered external thread to form a pair of sliding bearings. The number of sliding bearings is adjusted according to application conditions. Namely, the number of the effective bidirectional jointed, i.e., the effective bidirectional contact cohered, containing and contained thread pitches of the bidirectional tapered internal thread and the bidirectional tapered external thread is designed according to the application conditions. The multidirectional positioning of the internal cone body and the external cone body is formed through the containment of the bidirectional truncated cone body by the bidirectional tapered hole and the positioning in multiple directions such as radial, axial, angular and circumferential directions, preferably through the containment of the bidirectional truncated cone body by the bidirectional tapered hole and the main positioning in the radial and circumferential directions supplemented by the auxiliary positioning in the axial and angular directions, till the conical surface of the bidirectional tapered hole is cohered with the conical surface of the bidirectional truncated cone body to implement self-positioning or till the sizing interference contact is achieved to generate self-locking, which constitutes a special synthesis technology of the cone pair and the thread pair to ensure the precision, efficiency and reliability of the tapered thread technology, particularly the transmission connection of the olive-shaped asymmetric bidirectional tapered thread connection pair.

When the olive-like shaped asymmetric bidirectional tapered thread connection pair is used for fastening connection and sealing connection, the technical performances such as connection, locking, anti-loose, bearing and sealing performances, are realized through the screwing connection of the bidirectional tapered hole and the bidirectional truncated cone body, i.e., are realized through the sizing of the first helical conical surface of the truncated cone body and the first helical conical surface of the tapered hole till interference and/or the sizing of the second helical conical surface of the truncated cone body and the second helical conical surface of the tapered hole till interference. The load is borne in one direction and/or respectively borne in two directions at the same time according to the application conditions, i.e., the bidirectional truncated cone body and the bidirectional tapered hole are guided by the helical line to align the inner diameter and the outer diameter of the internal cone and the external cone till the first helical conical surface of the tapered hole is adhered with the first helical conical surface of the truncated cone body till the sizing fit of bearing in one direction or simultaneously bearing in two directions or sizing interference contact is achieved, and/or the second helical conical surface of the tapered hole is cohered with the second helical conical surface of the truncated cone body till the sizing fit of bearing in one direction or simultaneously bearing in two directions or sizing interference contact is achieved. Self-locking of containment of the bidirectional internal cone of the tapered internal thread and the bidirectional external cone of the tapered external thread and the multidirectional positioning in multiple directions such as radial, axial, angular and circumferential directions are formed, preferably through the containment of the bidirectional truncated cone body by the bidirectional tapered hole and the main positioning in the radial and circumferential directions supplemented by the auxiliary positioning in the axial and angular directions, till the conical surface of the bidirectional tapered hole is cohered with the conical surface of the bidirectional truncated cone body to implement self-positioning or till the sizing interference contact is achieved to generate self-locking, which constitutes a special synthesis technology of the cone pair and the thread pair and ensures efficiency and reliability of the tapered thread technology, particularly the olive-shaped asymmetric bidirectional tapered thread connection pair, so as to realize the technical performances of a mechanical mechanism, such as connection, locking, anti-loosening, bearing and sealing.

Therefore, the technical performances such as the transmission precision and efficiency, the load bearing capacity, the locking force of self-locking, the anti-loosening ability and the sealing performance of the mechanical mechanism using the olive-like shaped asymmetric bidirectional tapered thread connection pair are related to the sizes of the first helical conical surface of the truncated cone body and the formed left taper, i.e., the first taper angle α1, the second helical conical surface of the truncated cone body and the formed right taper, i.e., the second taper angle α2, and the sizes of the first helical conical surface of the tapered hole and the formed left taper, i.e., the first taper angle α1, and the second helical conical surface of the tapered hole and the formed right taper. Material friction coefficient, processing quality and application conditions of the columnar body and the cylindrical body also have a certain impact on the technical performances.

In the olive-like shaped asymmetric bidirectional tapered thread connection pair, when the right-angled trapezoid union rotates a circle at a constant speed, the axial movement distance of the right-angled trapezoid union is at least double the length of the sum of the right-angled sides of two right-angled trapezoids with the same lower bottom sides and upper bottom sides and different right-angled sides. The structure ensures that the first helical conical surface and the second helical conical surface of the truncated cone body and the first helical conical surface and the second helical conical surface of the tapered hole have sufficient length, thereby ensuring that the conical surface of the bidirectional truncated cone body and the conical surface of the bidirectional tapered hole have sufficient effective contact area and strength and the efficiency required by helical movement during fitting.

In the olive-like shaped asymmetric bidirectional tapered thread connection pair, when the right-angled trapezoid union rotates a circle at a constant speed, the axial movement distance of the right-angled trapezoid union is equal to the length of the sum of the right-angled sides of two right-angled trapezoids with the same lower bottom sides and upper bottom sides and different right-angled sides. The structure ensures that the first helical conical surface of the truncated cone body and the second helical conical surface of the truncated cone body and the first helical conical surface and the second helical conical surface of the tapered hole have sufficient length, thereby ensuring that the conical surface of the bidirectional truncated cone body and the conical surface of the bidirectional tapered hole have sufficient effective contact area and strength and the efficiency required by helical movement during fitting.

In the olive-like shaped asymmetric bidirectional tapered thread connection pair, the first helical conical surface of the truncated cone body and the second helical conical surface of the truncated cone body are both continuous helical surfaces or discontinuous helical surfaces; and the first helical conical surface of the tapered hole and the second helical conical surface of the tapered hole are both continuous helical surfaces or discontinuous helical surfaces. It is preferable that, the first helical conical surface of the truncated cone body and the second helical conical surface of the truncated cone body and the first helical conical surface of the tapered hole and the second helical conical surface of the tapered hole are all continuous helical surfaces.

In the olive-like shaped asymmetric bidirectional tapered thread connection pair, when the connecting hole of the cylindrical body is screwed into the screw-in end of the columnar body, the screw-in direction is required, i.e., the connecting hole of the cylindrical body cannot be reversely screwed in. The contact surface of the first helical conical surface of the truncated cone body and the first helical conical surface of the tapered hole is a bearing surface and/or is in interference fit and/or the contact surface of the second helical conical surface of the truncated cone body and the second helical conical surface of the tapered hole is a bearing surface and/or is in interference fit. The angle between two plain lines of the left conical surface of the internal thread and/or the external thread herein, i.e., the first helical conical surface, i.e., the first taper angle, and the angle between two plain lines of the right conical surface of the internal thread and/or the external thread, i.e., the second helical conical surface, i.e., the second taper angle, have opposite taper directions. Therefore, the thread connection function is realized by the contact and/or interference fit between the first helical conical surface of the internal thread and the first helical conical surface of the external thread and/or the contact and/or interference fit between the second helical conical surface of the internal thread and the second helical conical surface of the external thread.

In the olive-like shaped asymmetric bidirectional tapered thread connection pair, a head with the size greater than an outer diameter of the columnar body is arranged at one end of the columnar body, and/or a head with the size smaller than a minor diameter of the bidirectional tapered external thread of the columnar body is arranged at one end and/or two ends of the columnar body, wherein the connecting hole is a threaded hole formed in a nut. Namely, the columnar body connected with the head is a bolt; and the columnar body having no head and/or having heads at both ends smaller than the minor diameter of the bidirectional tapered external thread and/or having no thread at the middle and having the bidirectional tapered external threads at both ends is a stud, wherein the connecting hole is formed in the nut.

Compared with the prior art, the olive-like shaped asymmetric bidirectional tapered thread connection pair has the advantages of reasonable design, simple structure, convenient operation, large locking force, high bearing capacity, excellent anti-loosening performance, high transmission efficiency and precision, good mechanical sealing effect and good stability, realizes the fastening and connecting functions through bidirectional bearing or sizing of the cone pair formed by coaxially aligning the inner diameter and the outer diameter of the internal cone and the external cone to achieve interference fit, can prevent loosening phenomenon during connection, and has self-locking and self-positioning functions.

### DESCRIPTION OF THE DRAWINGS

FIG. 1 is a structural schematic diagram of an olive-like shaped (a left taper is smaller than a right taper) asymmetric bidirectional tapered thread connection pair according to an embodiment 1 of the present invention;

FIG. 2 is a structural schematic diagram of an external thread of the olive-like shaped (the left taper is smaller than the right taper) asymmetric bidirectional tapered thread and a complete unit thread of the external thread according to the embodiment 1 of the present invention;

FIG. 3 is a structural schematic diagram of an internal thread of an olive-like shaped (the left taper is smaller than the right taper) asymmetric bidirectional tapered thread and a complete unit thread of the internal thread according to the embodiment 1 of the present invention;

FIG. 4 is a structural schematic diagram of an olive-like shaped (the left taper is smaller than the right taper) asymmetric bidirectional tapered thread connection pair according to an embodiment 2 of the present invention;

FIG. 5 is a structural schematic diagram of an olive-like shaped (the left taper is smaller than the right taper) asymmetric bidirectional tapered thread connection pair according to the embodiment 3 of the present invention;

FIG. 6 is a structural schematic diagram of an olive-like shaped (the left taper is smaller than the right taper) asymmetric bidirectional tapered thread according to the embodiment 4 of the present invention;

FIG. 7 is a structural schematic diagram of an olive-like shaped (the left taper is smaller than the right taper) asymmetric bidirectional tapered thread according to the embodiment 5 of the present invention;

FIG. 8 is a graphic presentation of “the thread of the existing thread technology is an inclined plane on a cylindrical or conical surface” involved in the background of the present invention;

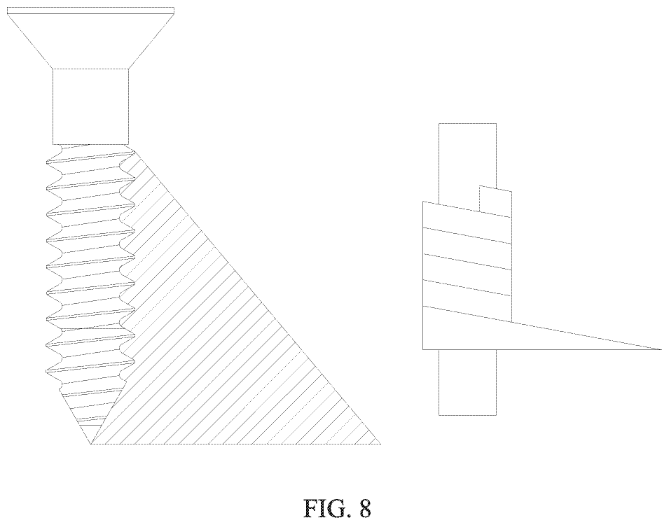

FIG. 9 is a graphic presentation of “an inclined plane slider model of the principle of the existing thread technology-the principle of inclined plane” involved in the background of the present invention; and

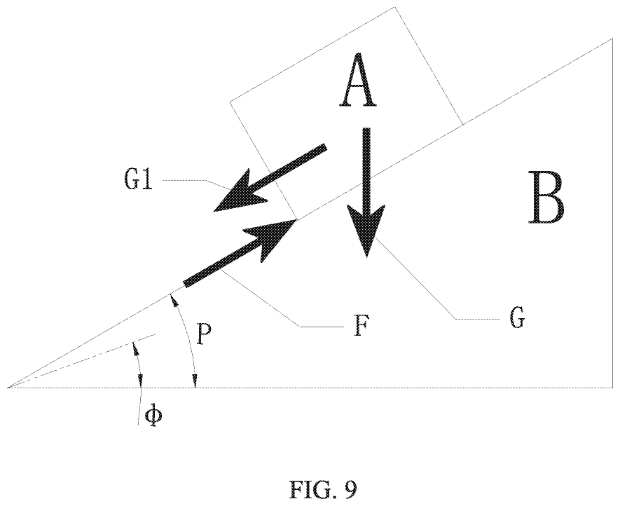

FIG. 10 is a graphic presentation of “a thread rise angle of the existing thread technology” involved in the background of the present invention.

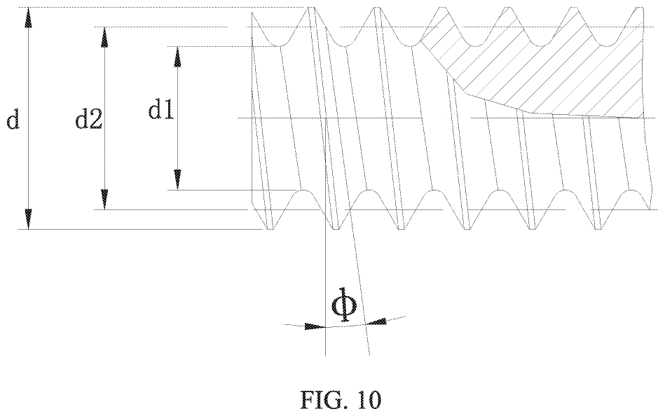

In the figures, tapered thread 1, cylindrical body 2, nut body 21, columnar body 3, screw body 31, tapered hole 4, bidirectional tapered hole 41, conical surface 42 of bidirectional tapered hole, first helical conical surface 421 of tapered hole, first taper angle α1, second helical conical surface 422 of tapered hole, second taper angle α2, internal helical line 5, internal thread 6, bidirectional tapered internal thread groove 61, bidirectional tapered internal thread plane or arc 62, truncated cone body 7, bidirectional truncated cone body 71, conical surface 72 of the bidirectional truncated cone body, first helical conical surface 721 of the truncated cone body, first taper angle α1, second helical conical surface 722 of the truncated cone body, second taper angle α2, external helical line 8, external thread 9, bidirectional tapered external thread groove 91, bidirectional tapered external thread plane or arc 92, olive-like shape 93, left taper 95, right taper 96, left-direction distribution 97, right-direction distribution 98, thread connection pair and/or thread pair 10, clearance 101, cone axis 01, thread axis 02, slider A on the inclined surface, inclined surface B, gravity G, gravity component G1 along the inclined plane, friction force F, thread rise angle φ, equivalent friction angle P, major diameter d of the traditional external thread, minor diameter d1 of the traditional external thread and pitch diameter d2 of the traditional external thread.

### DETAILED DESCRIPTION OF PREFERRED EMBODIMENTS

The present invention will be further described in detail below with reference to the accompany drawings and specific embodiments.

### Embodiment 1

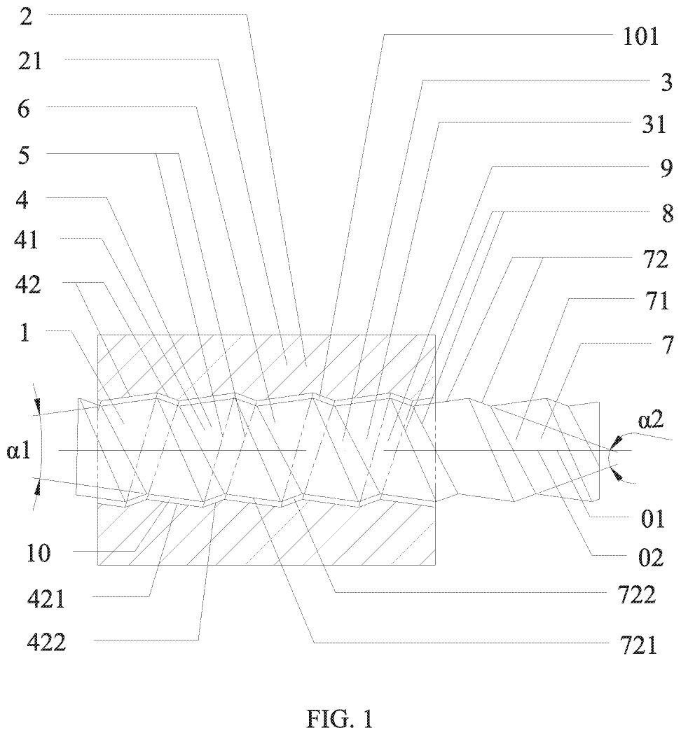

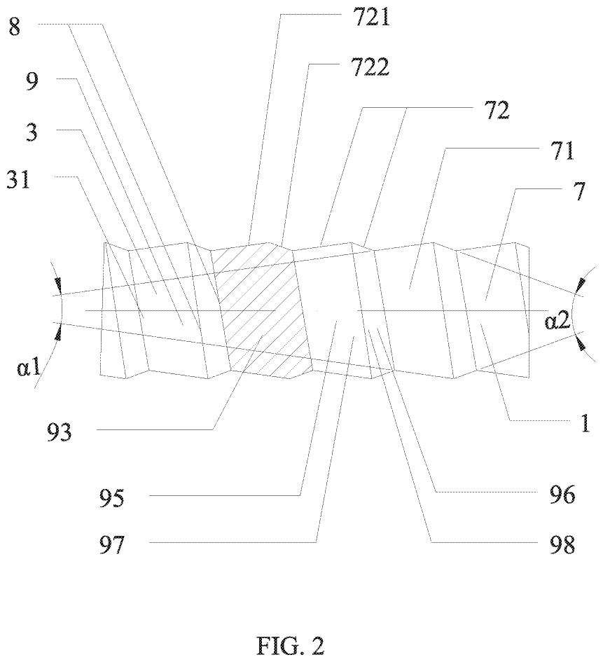

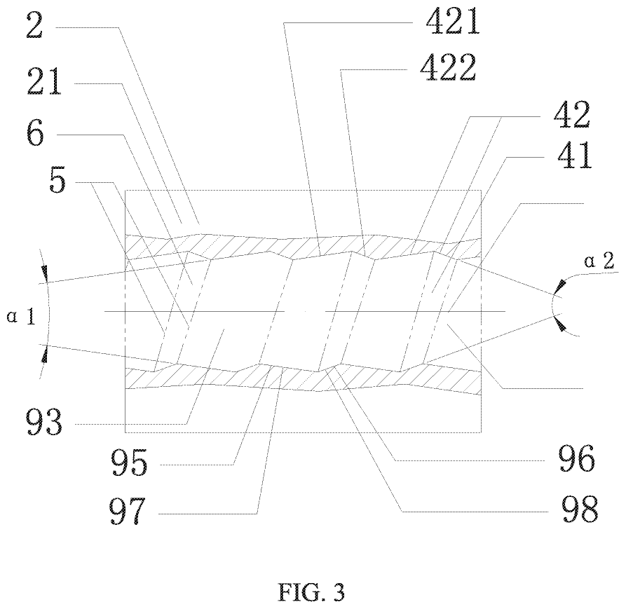

As shown in FIGS. 1, 2 and 3, an olive-like shaped asymmetric bidirectional tapered thread connection pair comprises a bidirectional truncated cone body 71 helically distributed on an outer surface of a columnar body 3 and a bidirectional tapered hole 41 helically distributed in an inner surface of a cylindrical body 2, namely, comprises an external thread 9 and an internal thread 6 which are in threaded fitting with each other. The internal thread 6 is distributed as a helical bidirectional helical tapered hole 41 and exists in the form of “non-entity space”; and the external thread 9 is a distributed as a helical bidirectional truncated cone body 71 and exists in the form of “material entity”. The internal thread 6 and the external thread 9 are subjected to a relationship of containing part and contained part. The internal thread 6 and the external thread 9 are sleeved together by screwing pitch by pitch in bidirectional tapered geometry and cohered till interference fit is achieved, i.e., the bidirectional tapered hole 41 contains the bidirectional truncated cone body 71 pitch by pitch. The bidirectional containment limits the disordered degree of freedom between the tapered hole 4 and the truncated cone body 7; the helical movement enables the asymmetric bidirectional tapered thread connection pair 10 to obtain the necessary ordered degree of freedom, thereby effectively synthesizing the technical characteristics of the cone pair and the thread pair.

When the olive-like shaped asymmetric bidirectional tapered thread connection pair is used in the present embodiment, a conical surface 72 of the bidirectional truncated cone body is fitted with a conical surface 42 of the bidirectional tapered hole.

The asymmetric bidirectional tapered thread connection pair 10 in the present embodiment has the self-locking and self-positioning performances only when the truncated cone body 7 and/or the tapered hole 4 of the olive-like shaped asymmetric bidirectional tapered thread connection pair reaches a certain taper, i.e., the cone bodies forming the cone pair reach a certain taper angle. The taper comprises a left taper 95 and a right taper 96, i.e., the taper angle comprises a left taper angle and a right taper angle. The asymmetric bidirectional tapered thread 1 has the left taper 95 smaller than the right taper 96. The left taper 95 corresponds to the left taper angle, i.e., a first taper angle α1. Preferably, the first taper angle α1 is greater than 0° and smaller than 53°; and preferably, the first taper angle α1 is 2°-40°. The right taper 96 corresponds to the right taper angle, i.e., a second taper angle α2. Preferably, the second taper angle α2 is greater than 0° and smaller than 53°; and preferably, the second taper angle α2 is 2°-40°. In individual special fields, that is, in connection application fields in which the self-locking performance is not needed and/or the self-positioning requirement is low and/or an axial bearing force requirement is high, preferably, the second taper angle α2 is greater than or equal to 53° and smaller than 180°; and preferably, the second taper angle α2 is 53°-90°.

The external thread 9 is arranged on the outer surface of the columnar body 3, wherein the columnar body 3 is provided with a screw body 31; the truncated cone body 7 is helically distributed on the outer surface of the screw body 31; and the truncated cone body 7 comprises the asymmetric bidirectional truncated cone body 71. The asymmetric bidirectional truncated cone body 71 is a special bidirectional tapered geometry in the olive shape 93. The columnar body 3 may be solid or hollow, comprising cylinders, cones, tubes and the like.

The asymmetric bidirectional truncated cone body 71 in the olive-like shape 93 is formed by symmetrically and oppositely jointing lower bottom surfaces of two truncated cone bodies with the same lower bottom surfaces and upper top surfaces and different cone heights and taper of the left truncated cone body smaller than taper of the right truncated cone body. The upper top surfaces are located at both ends of the bidirectional truncated cone body 71 to form the asymmetric bidirectional tapered thread 1 in the olive-like shape 93, the process comprises that the lower bottom surfaces are respectively jointed with the upper top surfaces of the adjacent bidirectional truncated cone bodies 71 and/or will be respectively jointed with the upper top surfaces of the adjacent bidirectional truncated cone bodies 71. The outer surface of the truncated cone body 71 is provided with a conical surface 72 of the asymmetric bidirectional truncated cone body. The external thread 9 comprises a first helical conical surface 721 of the truncated cone body, a second helical conical surface 722 of the truncated cone body and an external helical line 8. In the cross section through which the thread axis 02 passes, the complete single-pitch asymmetric bidirectional tapered external thread 9 is a special bidirectional tapered geometry in the olive-like shape 93 and with a large middle and two small ends and with the taper of the left truncated cone body smaller than the taper of the right truncated cone body. The angle formed between two plain lines of the left conical surface of the bidirectional truncated cone body 71, i.e., the first helical conical surface 721 of the truncated cone body, is the first taper angle α1. The left taper 95 formed on the first helical conical surface 721 of the truncated cone body corresponds to the first taper angle α1 and is subjected to a left-direction distribution 97. The angle formed between the two plain lines of the right conical surface of the asymmetric bidirectional truncated cone body 71, i.e., the second helical conical surface 722 of the truncated cone body, is the second taper angle α2. The right taper 96 formed on the second helical conical surface 722 of the truncated cone body corresponds to the second taper angle α2 and is subjected to a right-direction distribution 98. The taper directions corresponding to the first taper angle α1 and the second taper angle α2 are opposite. The plain line is an intersection line of the conical surface and the plane through which the cone axis passes 01. The shape formed by the first helical conical surface 721 and the second helical conical surface 722 of the truncated cone body of the bidirectional truncated cone body 71 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body 3, wherein the right-angled side is coincident with the central axis of the columnar body 3; and the right-angled trapezoid union is formed by symmetrically and oppositely jointing lower bottom sides of two right-angled trapezoids with the same lower bottom sides and upper bottom sides and different right-angled sides. The right-angled trapezoid union refers to a special geometry, which is formed by symmetrically and oppositely jointing the lower bottom sides of two right-angled trapezoids with the same lower bottom sides and upper bottom sides and different right-angled sides and has the upper bottom sides respectively located at both ends of the right-angled trapezoid union.

The internal thread 6 is arranged on the inner surface of the cylindrical body 2. The cylindrical body 2 is provided with a nut body 21. Helically distributed tapered holes 4 are formed in the inner surface of the nut body 21. The tapered holes 4 comprise asymmetric bidirectional tapered holes 41. The asymmetric bidirectional tapered hole 41 is a special bidirectional tapered geometry in the olive shape 93. The cylindrical body 2 comprises cylindrical and/or non-cylindrical workpieces and objects that need to be machined with the internal threads on the inner surfaces.

The asymmetric bidirectional tapered hole 41 in the olive-like shape 93 is formed by symmetrically and oppositely jointing lower bottom surfaces of two tapered holes with the same lower bottom surfaces and upper top surfaces and different cone heights and taper of the left tapered hole smaller than taper of the right tapered hole. The upper top surfaces are located at both ends of the bidirectional tapered hole 41 to form the asymmetric bidirectional tapered thread 1 in the olive-like shape 93, the process comprises that the upper top surfaces are respectively jointed with the upper top surfaces of the adjacent bidirectional tapered holes 41 and/or will be respectively jointed with the upper top surfaces of the adjacent bidirectional tapered holes 41 to form the thread. The internal thread 6 comprises a first helical conical surface 421 of the tapered hole, a second helical conical surface 422 of the tapered hole and an internal helical line 5. In the cross section through which the thread axis 02 passes, the complete single-pitch asymmetric bidirectional tapered internal thread 6, is a special bidirectional tapered geometry in the olive-like shape 93 and with a large middle and two small ends and left taper smaller than right taper. The angle formed between the two plain lines of the left conical surface of the bidirectional tapered hole 41, i.e., the first helical conical surface 421 of the tapered hole, is the first taper angle α1. The left taper 95 formed on the first helical conical surface 421 of the tapered hole corresponds to the first taper angle α1 and is subjected to a left-direction distribution 97. The angle formed between the two plain lines of the right conical surface of the bidirectional tapered hole 41, i.e., the second helical conical surface 422 of the tapered hole, is the second taper angle α2. The right taper 96 formed on the second helical conical surface 422 of the tapered hole corresponds to the second taper angle α2 and is subjected to a right-direction distribution 98. The taper directions corresponding to the first taper angle α1 and the second taper angle α2 are opposite. The plain line is an intersection line of the conical surface and the plane through which the cone axis passes 01. The shape formed by the first helical conical surface 421 and the second helical conical surface 422 of the tapered hole of the bidirectional tapered hole 41 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body 2, wherein the right-angled side is coincident with the central axis of the columnar body; and the right-angled trapezoid union is formed by symmetrically and oppositely jointing lower bottom sides of two right-angled trapezoids with the same lower bottom sides and upper bottom sides and different right-angled sides. The right-angled trapezoid union refers to a special geometry, which is formed by symmetrically and oppositely jointing the lower bottom sides of two right-angled trapezoids with the same lower bottom sides and upper bottom sides and different right-angled sides and has the upper bottom sides respectively located at both ends of the right-angled trapezoid union.

In the olive-like shaped asymmetric bidirectional tapered thread connection pair in the present embodiment, the joints of the adjacent helical conical surfaces of the external thread 9 and the joints of the adjacent helical conical surfaces of the internal thread 6 adopt a sharp angle connected form; and relative to the non-sharp angle, the sharp angle refers to a structural form that is not specially subjected to non-sharp angle treatment.

In the bidirectional truncated cone body 71 and the bidirectional tapered hole 41 in the olive-like shape 93, the joints between the first helical conical surface 721 of the truncated cone body of the bidirectional truncated cone body 71 and the second helical conical surface 722 of the truncated cone body in the same helix, i.e., large diameters of the external thread 9, are connected by an external sharp angle structure, and an external helical line 8 distributed helically is formed. The joints between the first helical conical surface 721 of the truncated cone body of the bidirectional truncated cone body 71 and the second helical conical surface 722 of a truncated cone body adjacent to the bidirectional truncated cone body 71 in the same helix, and/or the joints between the second helical conical surface 722 of the truncated cone body of the bidirectional truncated cone body 71 and the first helical conical surface 721 of a truncated cone body adjacent to the bidirectional truncated cone body 71 in the same helix, i.e., small diameters of the external thread 9, are connected by an internal sharp angle shape structure, and an external helical line 8 distributed helically is formed. The joints between the first helical conical surface 421 of the tapered hole of the bidirectional tapered hole 41 and the second helical conical surface 422 of the tapered hole in the same helix, i.e., large diameters of the internal thread 6, are connected by an internal sharp angle shape structure, and an internal helical line 5 distributed helically is formed. The joints between the first helical conical surface 421 of the tapered hole of the bidirectional tapered hole 41 and the second helical conical surface 422 of the tapered hole of the adjacent bidirectional tapered hole 41 and/or the joints between the second helical conical surface 422 of the tapered hole of the bidirectional tapered hole 41 and the first helical conical surface 421 of the tapered hole of the adjacent bidirectional tapered hole 41 in the same helix, i.e., small diameters of the internal thread 6, are connected by an external sharp angle shape structure, and an internal helical line 5 distributed helically is formed. The more compact the thread structure is, the higher the strength is, and the higher the force bearing value is. Excellent mechanical connection, locking and sealing performances are achieved; and physical machining spaces of the tapered threads are wider

In the olive-like shaped asymmetric bidirectional tapered thread connection pair in the present embodiment, during transmission connection, by virtue of screwed connection between the bidirectional tapered hole 41 and the bidirectional truncated cone body 71 and bidirectional bearing, when the external thread 9 and the internal thread 6 form the thread pair 10, a clearance 101 must be reserved between the internal thread 6 and the external thread 9, i.e., a clearance 101 must be reserved between the bidirectional truncated cone body 71 and the bidirectional tapered hole 41. If oil and other media exist between the internal thread 6 and the external thread 9 for lubrication, a bearing oil film will be easily formed; and the clearance 101 is beneficial to the formation of the bearing oil film. The asymmetric bidirectional tapered thread connection pair 10 is equivalent to a set of sliding bearing pairs composed of one and/or several pairs of sliding bearings, i.e., each pitch of the bidirectional tapered internal thread 6 bidirectionally contains a corresponding pitch of bidirectional tapered external thread 9 to form a pair of sliding bearings. The number of sliding bearings is adjusted according to application conditions. Namely, the number of the effective jointed, containing and contained thread pitches of the bidirectional tapered internal thread 6 and the bidirectional tapered external thread 9 is designed according to the application conditions. The multidirectional positioning in multiple directions such as radial, axial, angular and circumferential directions, preferably through the containment of the bidirectional external cone 9 by the bidirectional internal cone 6 constitutes a special synthesis technology of the special cone pair and the thread pair to ensure the precision, efficiency and reliability of the tapered thread technology, particularly the transmission connection of the olive-like shaped asymmetric bidirectional tapered thread connection pair 10.

When the olive-like shaped asymmetric bidirectional tapered thread connection pair in the present embodiment is used for fastening connection and sealing connection, the technical performances such as connection, locking, anti-loosening, bearing, fatigue and seal are realized through the screwing connection of the bidirectional tapered hole 41 and the bidirectional truncated cone body 71, i.e., are realized through the sizing of the first helical conical surface 721 of the truncated cone body and the first helical conical surface 421 of the tapered hole till interference and/or the sizing of the second helical conical surface 722 of the truncated cone body and the second helical conical surface 422 of the tapered hole till interference. The load is borne in one direction and/or respectively borne in two directions at the same time according to the application conditions, i.e., the bidirectional truncated cone body 71 and the bidirectional tapered hole 41 are guided by the helical line to align the inner diameter and the outer diameter of the internal cone and the external cone till the first helical conical surface 421 of the tapered hole is adhered with the first helical conical surface 721 of the truncated cone body till the interference contact is achieved, and/or the second helical conical surface 422 of the tapered hole is cohered with the second helical conical surface 722 of the truncated cone body till the sizing interference contact is achieved, so as to realize the technical performances of a mechanical mechanism, such as connection performance, locking performance, anti-loosening performance, bearing performance, fatigue performance and sealing performance.

Therefore, the technical performances such as the transmission precision and efficiency, the load bearing capacity, the locking force of self-locking, the anti-loosening ability and the sealing performance of the mechanical mechanism using the olive-like shaped asymmetric bidirectional tapered thread connection pair are related to the sizes of the first helical conical surface 721 of the truncated cone body and the formed left taper 95, i.e., the first taper angle α1, the second helical conical surface 722 of the truncated cone body and the formed right taper 96, i.e., the second taper angle α2, and the sizes of the first helical conical surface 421 of the tapered hole and the formed left taper 95, i.e., the first taper angle α1, and the second helical conical surface 422 of the tapered hole and the formed right taper 96. Material friction coefficient, processing quality and application conditions of the columnar body 3 and the cylindrical body 2 also have a certain impact on the technical performances.

In the olive-like shaped asymmetric bidirectional tapered thread connection pair, when the right-angled trapezoid union rotates a circle at a constant speed, the axial movement distance of the right-angled trapezoid union is at least double the length of the sum of the right-angled sides of two right-angled trapezoids with the same lower bottom sides and upper bottom sides and different right-angled sides. The structure ensures that the first helical conical surface 721 and the second helical conical surface 722 of the truncated cone body and the first helical conical surface 421 and the second helical conical surface 422 of the tapered hole have sufficient length, thereby ensuring that the conical surface 72 of the bidirectional truncated cone body and the conical surface 42 of the bidirectional tapered hole have sufficient effective contact area and strength and the efficiency required by helical movement during fitting.

In the olive-like shaped asymmetric bidirectional tapered thread connection pair, when the right-angled trapezoid union rotates a circle at a constant speed, the axial movement distance of the right-angled trapezoid union is equal to the length of the sum of the right-angled sides of two right-angled trapezoids with the same lower bottom sides and upper bottom sides and different right-angled sides. The structure ensures that the first helical conical surface 721 of the truncated cone body and the second helical conical surface 722 of the truncated cone body and the first helical conical surface 421 and the second helical conical surface 422 of the tapered hole have sufficient length, thereby ensuring that the conical surface 72 of the bidirectional truncated cone body and the conical surface 42 of the bidirectional tapered hole have sufficient effective contact area and strength and the efficiency required by helical movement during fitting.

In the olive-like shaped asymmetric bidirectional tapered thread connection pair, the first helical conical surface 721 of the truncated cone body and the second helical conical surface 722 of the truncated cone body are both continuous helical surfaces or discontinuous helical surfaces; and the first helical conical surface 421 of the tapered hole and the second helical conical surface 422 of the tapered hole are both continuous helical surfaces or discontinuous helical surfaces. It is preferable that, the first helical conical surface 721 of the truncated cone body and the second helical conical surface 722 of the truncated cone body and the first helical conical surface 421 of the tapered hole and the second helical conical surface 422 of the tapered hole are all continuous helical surfaces

In the olive-like shaped asymmetric bidirectional tapered thread connection pair, when the connecting hole of the cylindrical body 2 is screwed into the screw-in end of the columnar body 3, the screw-in direction is required, i.e., the connecting hole of the cylindrical body 2 cannot be reversely screwed in.

In the olive-like shaped asymmetric bidirectional tapered thread connection pair, a head with the size greater than an outer diameter of the columnar body 3 is arranged at one end of the columnar body 3, and/or a head with the size smaller than a minor diameter of the bidirectional tapered external thread 9 of a screw body 31 of the columnar body 3 is arranged at one end and/or two ends of the columnar body 3, wherein the connecting hole is a threaded hole formed in a nut 21. Namely, the columnar body 3 connected with the head is a bolt; and the columnar body having no head and/or having heads at both ends smaller than the minor diameter of the bidirectional tapered external thread 9 and/or having no thread at the middle and having the bidirectional tapered external threads 9 at both ends is a stud, wherein the connecting hole is formed in the nut 21.

Compared with the prior art, the olive-like shaped asymmetric bidirectional tapered thread connection pair has the advantages of reasonable design, simple structure, convenient operation, large locking force, high bearing capacity, excellent anti-loosening performance, high transmission efficiency and precision, good mechanical sealing effect and good stability, realizes the fastening and connecting functions through bidirectional bearing or sizing of the cone pair formed by coaxially aligning the inner diameter and the outer diameter of the internal cone and the external cone to achieve interference fit, can prevent loosening phenomenon during connection, and has self-locking and self-positioning functions

### Embodiment 2

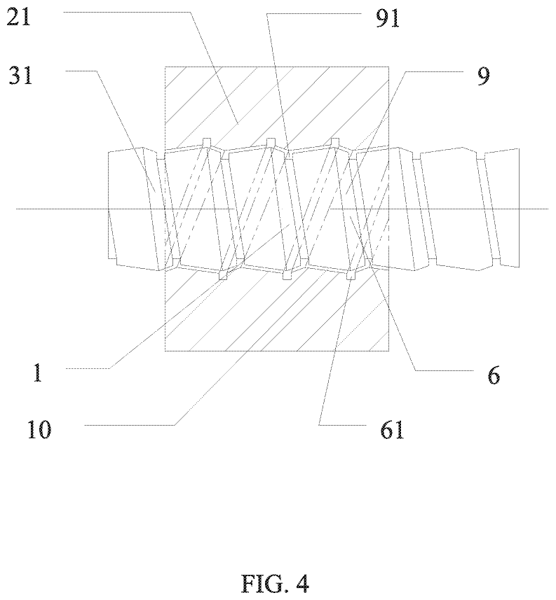

As shown in FIG. 4, the structures, principles and implementation steps in the present embodiment are similar to those in the embodiment 1. The differences are that, the small diameters of the external thread 9, i.e., the joints of the adjacent helical conical surfaces, are treated with the external helical structure connected by grooves 91; the external helical structure is a special external helical line 8; the large diameters of the internal threads 6 are treated with the internal thread structure connected by grooves 61; and the internal helical structure is a special internal helical line 5. Thus, interference between the internal thread 6 and the external thread 9 during screwing may be avoided, and oil or dirt may be stored.

### Embodiment 3

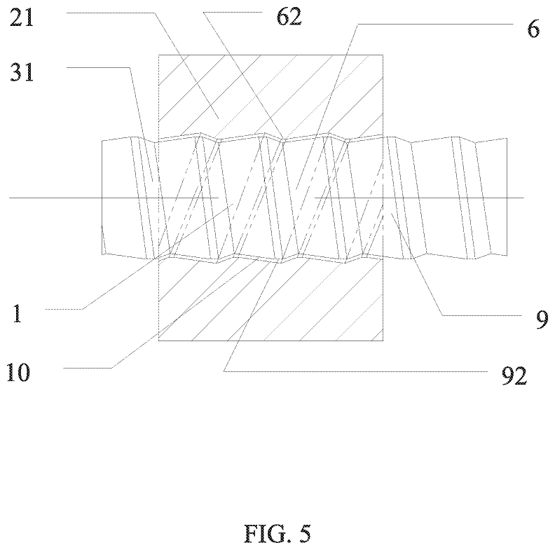

As shown in FIG. 5, the structures, principles and implementation steps in the present embodiment are similar to those in the embodiment 1. The differences are that, the large diameters of the external thread 9 are treated with an external helical structure connected by planes or arcs 92; the external helical structure is a special external helical line 8; the small diameters of the internal thread 6, i.e., the joints of the adjacent helical conical surfaces are treated with an internal helical structure connected by planes or arcs 62; and the internal helical structure is a special internal helical line 5. Thus, interference between the internal thread 6 and the external thread 9 during screwing may be avoided, and oil or dirt may be stored.

### Embodiment 4

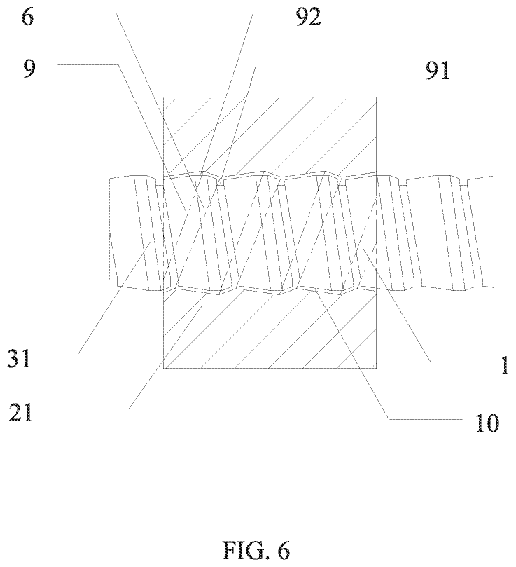

As shown in FIG. 6, the structures, principles and implementation steps in the present embodiment are similar to those in the embodiment 1. The differences are that, the small diameters of the external thread 9, i.e., the joints of the adjacent helical conical surfaces, are treated with an external helical structure connected by grooves 91; the large diameters of the external thread 9 are treated with an external helical structure connected by planes or arcs 92; the external helical structure is a special external helical line 8; the large and small diameters of the internal thread forming the thread pair 10 with the external thread are connected by sharp angles. A possible angle R of the formed thread pair 10 may be avoided. Thus, interference between the internal thread 6 and the external thread 9 during screwing may be avoided, and oil or dirt may be stored.

### Embodiment 5

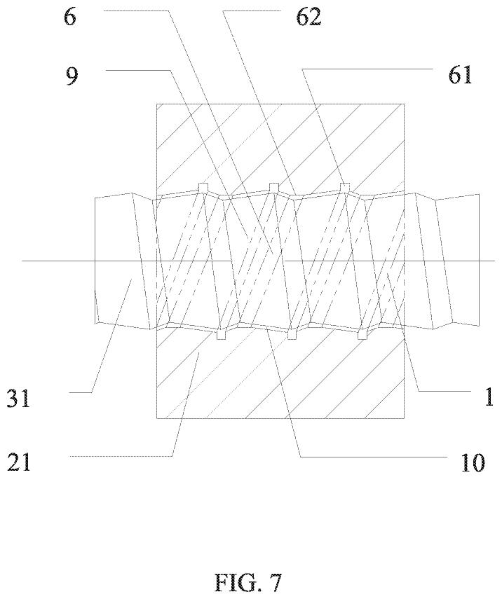

As shown in FIG. 7, the structures, principles and implementation steps in the present embodiment are similar to those in the embodiment 1. The differences are that, the large diameters of the internal thread 6 are treated with an internal helical structure connected by grooves 61; the small diameters of the internal thread 6, i.e., the joints of the adjacent helical conical surfaces, are treated with an internal helical structure connected by planes or arcs 62; the internal helical structure is a special internal helical line 5; the large and small diameters of the external thread 9 forming the thread pair 10 with the internal thread are connected by sharp angles. A possible angle R of the formed thread pair 10 may be avoided. Thus, interference between the internal thread 6 and the external thread 9 during screwing may be avoided, and oil or dirt may be stored.

The specific embodiments described herein are merely examples to illustrate the spirit of the present invention. Those skilled in the art of the present invention can make various modifications or supplements to the specific embodiments described or substitute with similar modes without deviating from the spirit of the present invention or going beyond the scope defined by the appended claims.

The terms such as tapered thread 1, cylindrical body 2, nut body 21, columnar body 3, screw body 31, tapered hole 4, bidirectional tapered hole 41, conical surface 42 of bidirectional tapered hole, first helical conical surface 421 of tapered hole, first taper angle α1, second helical conical surface 422 of tapered hole, second taper angle α2, internal helical line 5, internal thread 6, bidirectional tapered internal thread groove 61, bidirectional tapered internal thread plane or arc 62, truncated cone body 7, bidirectional truncated cone body 71, conical surface 72 of the bidirectional truncated cone body, first helical conical surface 721 of the truncated cone body, first taper angle α1, second helical conical surface 722 of the truncated cone body, second taper angle α2, external helical line 8, external thread 9, bidirectional tapered external thread groove 91, bidirectional tapered external thread plane or arc 92, olive-like shape 93, left taper 95, right taper 96, left-direction distribution 97, right-direction distribution 98, thread connection pair and/or thread pair 10, clearance 101, self-locking force, self-locking, self-positioning, pressure, cone axis 01, thread axis 02, mirror image, shaft sleeve, shaft, non-entity space, material entity, single tapered body, double tapered body, cone body, internal cone body, tapered hole, external cone body, taper body, cone pair, helical structure, helical movement, thread body, complete unit thread, axial force, axial force angle, counter-axial force, counter-axial force angle, centripetal force, counter-centripetal force, reversely collinear, internal stress, bidirectional force, unidirectional force, sliding bearing, sliding bearing pair, and the like are widely used, but the possibility of using other terms is not excluded. These terms are merely used to describe and explain the essence of the present invention more conveniently; and it is contrary to the spirit of the present invention to interpret the terms as any additional limitation.

We claim:

1. An olive-shaped asymmetric bidirectional tapered thread connection pair with smaller left taper and greater right taper, i.e., an olive-like shaped (left taper is smaller than right taper) asymmetric bidirectional tapered thread, comprising: an external thread (9) and an internal thread (6) in thread fit, wherein a complete unit thread of the olive-like (left taper is smaller than right taper) asymmetric bidirectional tapered thread (1) is a helical asymmetric bidirectional tapered body in an olive-like shape (93) and with a left taper (95) smaller than a right taper (96) and with a large middle and two small ends, comprising a bidirectional tapered hole (41) and/or a bidirectional truncated cone body (71); a thread body of the internal thread (6) is a helical bidirectional tapered hole (41) on an inner surface of a cylindrical body (2) and exists in the form of “non-entity space”; a thread body of the external thread (9) is a helical bidirectional truncated cone body (71) on an outer surface of a columnar body (3) and exists in the form of “material entity”; the left taper (95) formed on a left tapered surface of the asymmetric bidirectional tapered body corresponds to a first taper angle (α1); the right taper (96) formed on a right tapered surface corresponds to a second taper angle (α2); the left taper (95) and the right taper (96) have opposite directions and different tapers; the internal thread (6) and the external thread (9) contain the cone body through tapered holes till inner and outer tapered surfaces bear each other; technical performances mainly depend on the size of conical surfaces and tapers of thread bodies fitted with each other; preferably, the first taper angle (α1) is greater than 0° and smaller than 53°; and the second taper angle (α2) is greater than 0° and smaller than 53°; and in individual special fields, preferably, the second taper angle (α2) is greater than or equal to 53° and smaller than 180°.

2. The thread connection pair according to claim 1, wherein the bidirectional tapered internal thread (6) in the olive-like shape (93) comprises a left conical surface of a conical surface (42) of the bidirectional tapered hole, i.e., a first helical conical surface (421) of the tapered hole, a right conical surface, i.e., a second helical conical surface (422) of the tapered hole, and an internal helical line (5); the shape formed by the first helical conical surface (421) of the tapered hole and the second helical conical surface (422) of the tapered hole, i.e., the bidirectional helical conical surfaces, is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body (2), wherein the right-angled side is coincident with the central axis of the cylindrical body (3); the right-angled trapezoid union is formed by symmetrically and oppositely jointing lower bottom sides of two right-angled trapezoids with the same lower bottom sides and upper bottom sides and different right-angled sides; the bidirectional tapered external thread (9) in the olive-like shape (93) comprises a left conical surface of a conical surface (72) of the bidirectional truncated cone body, i.e., a first helical conical surface (721) of the truncated cone body, a right conical surface, i.e., a second helical conical surface (722) of the truncated cone body, and an external helical line (8); the shape formed by the first helical conical surface (721) of the truncated cone body and the second helical conical surface (722) of the truncated cone body, i.e., the bidirectional helical conical surfaces, is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body (3), wherein the right-angled side is coincident with the central axis of the columnar body (3); and the right-angled trapezoid union is formed by symmetrically and oppositely jointing lower bottom sides of two right-angled trapezoids with the same lower bottom sides and upper bottom sides and different right-angled sides.

3. The thread connection pair according to claim 2, wherein when the right-angled trapezoid union rotates a circle at a constant speed, the axial movement distance of the right-angled trapezoid union is at least double the length of the sum of the right-angled sides of two right-angled trapezoids of the right-angled trapezoid union.

4. The thread connection pair according to claim 2, wherein when the right-angled trapezoid union rotates a circle at a constant speed, the axial movement distance of the right-angled trapezoid union is equal to the length of the sum of the right-angled sides of two right-angled trapezoids of the right-angled trapezoid union.

5. The thread connection pair according to claim 1, wherein the left conical surface and the right conical surface of the bidirectional tapered body, i.e., the first helical conical surface (421) of the tapered hole and the second helical conical surface (422) of the tapered hole and the internal helical line (5) are continuous helical surfaces or discontinuous helical surfaces; and/or the first helical conical surface (721) of the truncated cone body and the second helical conical surface (722) of the truncated cone body and the external helical line (8) are continuous helical surfaces or discontinuous helical surfaces.

6. The thread connection pair according to claim 1, wherein the internal thread (6) is formed by symmetrically and oppositely jointing the lower bottom surfaces of two tapered holes (4) with the same lower bottom surfaces and upper top surfaces and different cone heights, and the upper top surfaces are located at both ends of the bidirectional tapered hole (41) to form the asymmetric bidirectional tapered thread (1) in the olive-like shape (93), comprising that the upper top surfaces are respectively jointed with the upper top surfaces of the adjacent bidirectional tapered holes (41) and/or will be respectively jointed with the upper top surfaces of the adjacent bidirectional tapered holes (41) to form a helical shape to form the asymmetric bidirectional tapered internal thread (6) in the olive-like shape (93); the external thread (9) is formed by symmetrically and oppositely jointing the lower bottom surfaces of two truncated cone bodies (7) with the same lower bottom surfaces and upper top surfaces and different cone heights, and the upper top surfaces are located at both ends of the bidirectional truncated cone body (71) to form the asymmetric bidirectional tapered thread (1) in the olive-like shape (93), comprising that the upper top surfaces are respectively jointed with the upper top surfaces of the adjacent bidirectional truncated cone bodies (71) and/or will be respectively jointed with the upper top surfaces of the adjacent bidirectional truncated cone bodies (71) to form a helical shape to form the asymmetric bidirectional tapered external thread (9) in the olive-like shape (93).

7. The thread connection pair according to claim 1, wherein a large diameter of the external thread (9) is of an external sharp angle shape structure; a small diameter of the external thread (9) is of an internal sharp angle shape structure; a large diameter of the internal thread (6) is of an internal sharp angle shape structure; a small diameter of the internal thread (6) is of an external sharp angle shape structure; and/or the small diameter of the external thread (9) is treated with a groove (91) structure, and the large diameter of the internal thread (6) is treated with a groove (61) structure; the large diameter of the external thread (9) and the small diameter of the internal thread (6) are kept as a sharp angle structure, and/or the large diameter of the external thread (9) is treated with a planar or arc (92) structure, and the small diameter of the internal thread (6) is treated with a planar or arc (62) structure; the small diameter of the external thread (9) and the large diameter of the internal thread (6) are kept as a sharp angle structure, and/or the small diameter of the external thread (9) is treated with a groove (91) structure, and the large diameter of the internal thread (6) is treated with a groove (61) structure; and/or the small diameter of the external thread (9) is treated with a groove (91) structure, and the large diameter of the internal thread (6) is treated with a groove (61) structure; and the large diameter of the external thread (9) is treated with a planar or arc (92) structure, and the small diameter of the internal thread (6) is treated with a planar or arc (62) structure.

8. The thread connection pair according to claim 1, wherein the thread pair (10) composed of the internal thread (6) and the external thread (9) is formed as follows: the helical bidirectional tapered hole (41) and the helical bidirectional truncated cone body (71) are guided by the helical line to achieve mutual sizing interference so as to form cone pairs in pitches; a clearance (101) is reserved between the bidirectional truncated cone body (71) and the bidirectional tapered hole (41); the internal thread (6) of each pitch contains the external thread (9) of a corresponding pitch to achieve coaxial centered sizing so as to form a set of sliding bearings; the whole thread connection pair (10) is composed of one or several sets of sliding bearings; the number of the effective bidirectional jointed, i.e., the effective bidirectional contact cohered, containing and contained thread pitches of the internal thread (6) and the external thread (9) is designed according to the application conditions; multidirectional positioning is formed through bidirectional containment of the truncated cone body (7) of the external thread (9) by the tapered hole (4) of the internal thread (6) and exists in multiple directions such as radial, circumferential, axial and angular directions; and each pitch of the internal thread (6) and the external thread (9) comprises bidirectional bearing on one side and/or bidirectional bearing on the left and right sides.

9. The thread connection pair according to claim 1, wherein self-locking of the thread pair (10) composed of the internal thread (6) and the external thread (9) is produced as follows: the first helical conical surface (421) of the tapered hole and the second helical conical surface (422) of the tapered hole matched with the first helical conical surface (721) of the truncated cone body and the second helical conical surface (722) of the truncated cone body take the contact surface as the supporting surface to make the inner and outer cones are centered in inner and outer diameters under the guidance of the helical lines till the conical surface (72) of the bidirectional truncated cone body is cohered with the special conical surface (42) to achieve one-directional bearing of the helical conical surface and/or bidirectional simultaneous bearing of the helical conical surface and/or till the sizing fit and self-positioning contact and/or till the sizing interference contact.

10. The thread connection pair according to claim 1, wherein the columnar body (3) may be solid or hollow, comprising cylindrical and/or non-cylindrical workpieces and objects that need to be machined with bidirectional tapered external threads (9) on the outer surfaces; the cylindrical body (2) comprises cylindrical and/or non-cylindrical workpieces and objects that need to be machined with bidirectional tapered internal threads (6) on the inner surfaces; and the outer surfaces and/or inner surfaces comprise cylindrical surfaces, non-cylindrical surfaces such as conical surfaces, and other surface geometrical shapes.

11. The thread connection pair according to claim 1, wherein the internal thread (6) and/or the external thread (9) comprise single-pitch thread bodies that are incomplete tapered geometries, i.e., the single-pitch thread bodies are incomplete unit threads.
